(19) United States
(12) Patent Application Publication
(10) Pub. No.: US 2002/0116262 A1
(43) Pub. Date: Aug. 22, 2002

(54) System for promoting products

(76) Inventor: Robert John Mitchell, Alamo, CA (US)

Correspondence Address: MARSHALL, O'TOOLE, GERSTEIN,, MURRAY & BORUN, 6300 Sears Tower, 233 South Wacker Drive, Chicago, IL, 60606-6402, US

(21) Appl. No.: 09/790,001

(22) Filed: Feb. 21, 2001

(51) Int. Cl. G06F 17/60

(52) U.S. Cl. 705/14

(57) ABSTRACT

A system for promoting products (10) is disclosed which includes at least one terminal (12, 14) disposed at a point of sale. The terminal (12, 14) includes a communications device for facilitating transfer of communications through a communications network (16), and the terminal (12, 14) is arranged to receive an electronic address of a user. The system (10) also includes an electronic message generator arranged to generate an electronic message and forward the electronic message to the electronic address of the user, the electronic message including an address of a network information site (22) and a password useable to access the network information site (22).

### FIELD OF THE INVENTION

The present invention relates to a system for promoting products and, in particular, to such a system for use with Internet-based marketing.

### BACKGROUND OF THE INVENTION

It is known to carry out marketing on the Internet by forwarding electronic messages containing marketing information to electronic addresses of a plurality of Internet users. The electronic addresses may be obtained by generation of random electronic addresses or by obtaining the electronic addresses from organisations with which the users have been associated. However, with such an arrangement, it is difficult to determine information about the users, such as whether the users are existing customers of an organisation, or demographic information of the users. Such information about the users is useful for directed marketing to customers on the basis of location of the users or type of product purchased by the users.

In this specification, the term “electronic address” will be understood to refer to any identifier unique to a user of a communications network which is used to forward information in electronic form to the user associated with the identifier. An example of an electronic address is an e-mail address or a mobile phone number of a mobile phone arranged to receive SMS messages.

It will also be understood that the term “electronic message” refers to any message which is in a form suitable for transferral through a communications network such as the Internet. An example of an electronic message is an e-mail or an SMS message.

It will also be understood that the term “network information site” refers to a site of a communications network which is accessible by users and which contains information obtainable by the users when the site is accessed. Such a network information site may be a website.

### SUMMARY OF THE INVENTION

In accordance with a first aspect of the present invention, there is provided a system for promoting products, said system including at least one terminal disposed at a point of sale, said terminal including a communications device for facilitating transfer of communications through a communications network, and said terminal being arranged to receive an electronic address of a user, and an electronic message generator arranged to generate an electronic message and forward the electronic message to the electronic address of the user, said electronic message including an address of a network information site and a password useable to access the network information site.

Preferably, the electronic address is received as part of an off line transaction such as purchasing of a product at a vending machine or at a retail store.

In one embodiment, the system further includes a central controller, and the terminal is arranged to generate an intermediate electronic message and to forward the intermediate electronic message to the central controller, the intermediate electronic message including information indicative of the electronic address of the user.

Preferably, the system further includes a database for storing information relating to electronic messages, purchased product information and/or user demographic information.

The terminal may be a communications enabled vending machine. Alternatively, the terminal may be a communications enabled computing device.

In one embodiment, the communications device is arranged to facilitate communications through the Internet. With this embodiment, the electronic message may be an e-mail and the electronic address may be an e-mail address.

In an alternative embodiment, the communications device is arranged to facilitate communications through a mobile telephone communications network. With this embodiment, the electronic message may be an SMS message and the electronic address may be a telephone number of a mobile telephone.

Preferably, the network information site is a website and the website includes information relating to rewards, and/or to products and/or services on offer.

In accordance with a second aspect of the present invention, there is provided a method of promoting products, said method including the steps of providing at least one terminal disposed at a point of sale, said terminal including a communications device for facilitating transfer of communications through a communications network, receiving an electronic address of a user at said terminal, generating an electronic message including an address of a network information site and a password useable to access the network information site, and forwarding the electronic message to the electronic address of the user.

Preferably, the electronic address of a user is received as part of an off line transaction.

In one embodiment, the method further includes the steps of providing a central controller, generating an intermediate electronic message, and forwarding the intermediate electronic message to the central controller, said intermediate electronic message including information indicative of the electronic address of the user.

Preferably, the method further includes the step of providing a database for storing information relating to electronic messages, purchased product information and/or user demographic information.

The terminal may be a communications enabled vending machine. Alternatively, the terminal may be a communications enabled computing device.

In one embodiment, the method further includes the step of arranging the communications device to facilitate communications through the Internet. With this embodiment, the electronic message may be an e-mail and the electronic address may be an e-mail address.

In an alternative embodiment, the method further includes the step of arranging the communications device to facilitate communications through a mobile telephone communications network. With this embodiment, the electronic message may be an SMS message and the electronic address may be a telephone number of a mobile telephone.

Preferably, the network information site is a website and the website includes information relating to rewards, and/or to products and/or services on offer.

### BRIEF DESCRIPTION OF THE DRAWINGS

The present invention will now be described, by way of example only, with reference to the accompanying drawings, in which:

FIG. 1 is a block diagram of a system for promoting products in accordance with the present invention; and

FIG. 2 is a flow diagram illustrating operation of the embodiment shown in FIG. 1.

### DETAILED DESCRIPTION OF AN EMBODIMENT OF THE INVENTION

In a broad sense, the system for promoting products of the present invention operates so as to provide selected individuals with the means to connect to a website, the individuals being selected on the basis of an off line transaction such as purchase of a product at a point of sale, and the website providing the individuals with offers, rewards and such like. The invention is particularly useful for marketing purposes, since an operator of the system is able to easily determine the type of products purchased by users and the location of the purchase, and to generate an appropriate marketing strategy on the basis of this determination.

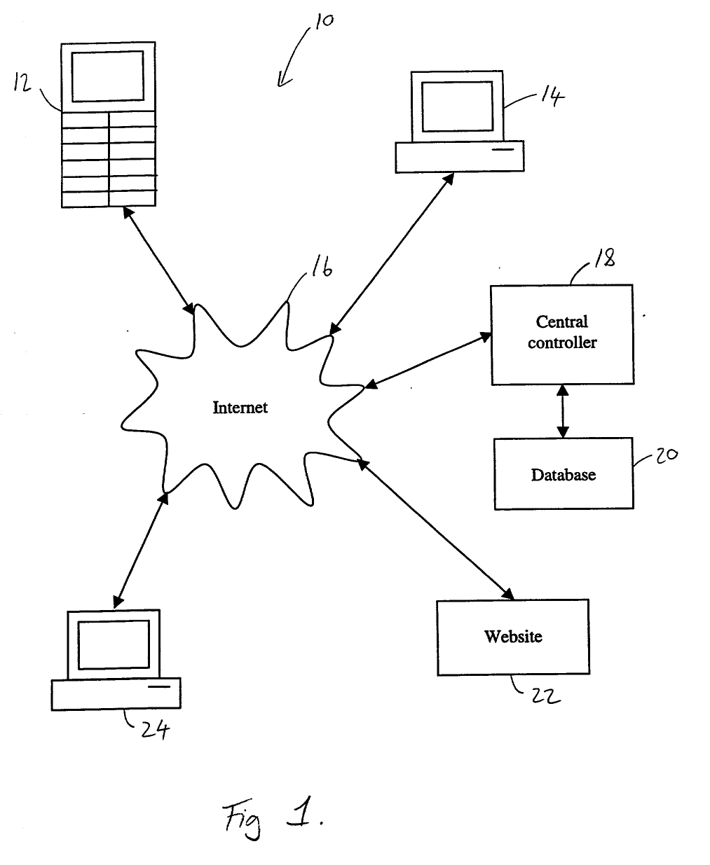

Referring to the drawings, in FIG. 1 there is shown a system for promoting products 10 which includes a point of sale terminal, in this example an Internet enabled vending machine 12 or an Internet enabled computing device 14. The Internet enabled vending machine 12 may be located at any location suitable for selling products. In embodiments which include Internet enabled computing devices 14, such computing devices 14 may be located at a retail outlet such as a shop.

An internet enabled vending machine is a vending machine containing products available for purchase by users, and provided with communication means and processing means for transferring information relating to products on offer in the machine or relating to manufacturers of the products to and from the vending machine through the Internet.

The point of sale terminals 12, 14 are connectable to a communications network, in this example the Internet 16, by any suitable communications mechanism such that electronic messages are transferable to and from the point of sale terminals 12, 14 through the Internet 16. The point of sales terminals 12, 14 are arranged to receive electronic messages such as e-mails or SMS messages as part of an off line transaction, such as purchase of a product.

The system for promoting products 10 also includes a central controller 18 connectable to the Internet 16 by any suitable communications mechanism such that electronic messages are transferable to and from the central controller 18 through the Internet 16. A database 20 is in electronic communication with the central controller 18, the database 20 serving to store information associated with electronic messages transferred through the system for promoting products 10. Such information may include information as to the sending location of the electronic messages, details of the products purchased by users, and/or other demographic information relating to the users. The central controller 18 serves to receive electronic messages, to generate electronic messages using information obtained from the received electronic messages, and to coordinate information transfer to and from the database 20.

The system for promoting products 10 also includes a website 22 which contains information relating to rewards available to users registered with the system or to products and/or services on offer to users registered with the system 10. The rewards or offers are provided by suppliers and/or manufacturers of products registered with the system or by other suppliers and/or manufacturers which have become associated-with the system but are not registered with the system.

The website 22 may also be arranged to receive further information relating to the users for future marketing purposes.

Also shown in FIG. 1 is a user terminal 24 in the form of a user computing device. Typically, the user terminal 24 would be located at the home of the user or at the workplace of the user.

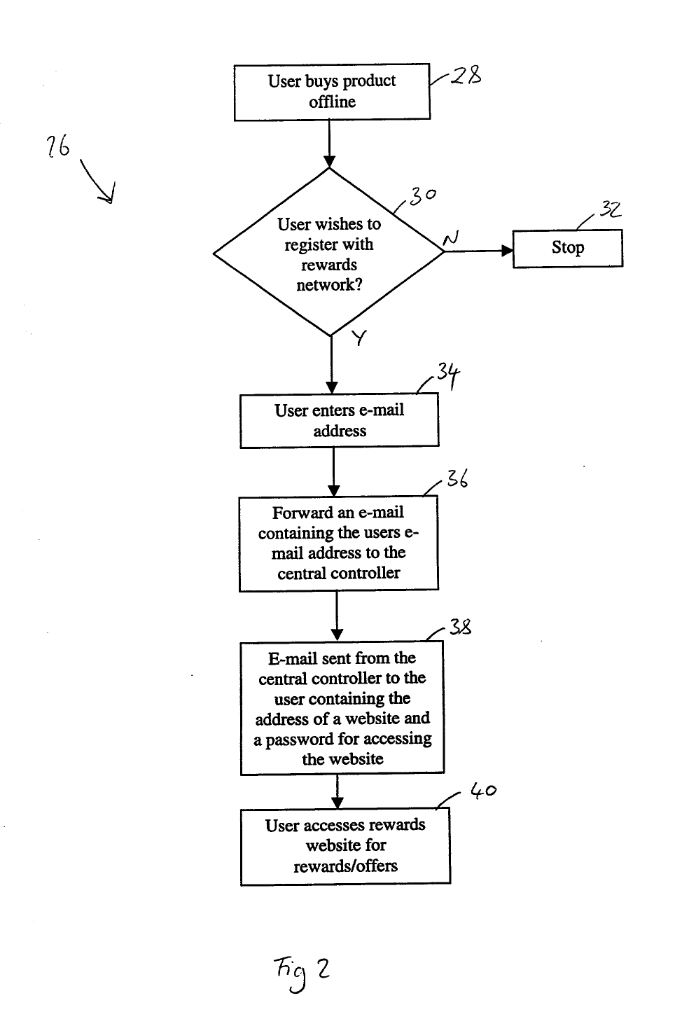

In operation, a user associated with the user terminal 24 purchases and receives a product from the Internet enabled vending machine 12 or, alternatively, from a retail outlet having an Internet enabled computing device 14. This is indicated at step 28 in the flow diagram 26 of FIG. 2.

However, it will be understood that the user may alternatively purchase a product from a vending machine 12 or from a retail outlet and receive the product at a later date.

If the product is associated with a manufacturer or supplier registered with the system, as part of the transaction process, the user is given the option of registering with the system 10 by providing the users e-mail address, as indicated at step 30 in FIG. 2. If the user declines to provide an e-mail address, no further action is taken, as indicated at step 32 in FIG. 2. If the user provides an e-mail address, an electronic message, in this example in the form of an e-mail, is generated by the point of sale terminal 12, 14 and forwarded, for example by e-mail, through the Internet 16 to the central controller 18, as indicated at steps 34 and 36 in FIG. 2. The electronic message generated by the point of sale terminal 12, 14 includes information indicative of the e-mail address of the user, and may be generated either automatically by the point of sale terminal 12, 14 on entering the users e-mail address, or manually by an operator of the point of sale terminal 12, 14. Following receipt of the e-mail by the central controller 18, the central controller 18 generates a further e-mail containing the address of the website 22 associated with the system 10 and a password useable to access the website 22. The central controller then forwards the further e-mail to the user at the users e-mail address, as indicated at step 38 in FIG. 2. Following receipt of the further e-mail at the user terminal 24, the user is able to directly access the website 22 by entering the password and thereby obtain rewards and/or offers available to registered users of the network, as indicated at step 40 in FIG. 2.

It will be appreciated that instead of providing a remote central controller 18 to receive an e-mail from the point of sale terminals 12, 14, and to generate a further e-mail to the user, the point of sale terminals 12, 14 may themselves be arranged to generate a further e-mail containing the address of the website 22 and a password to access the website, and to forward the further e-mail to the user.

It will also be appreciated that instead of providing Internet enabled point of sale terminals, point of sale terminals may be provided which are arranged to communicate with a mobile communications network. With this arrangement, the electronic messages may be SMS messages and the electronic addresses may be a mobile telephone number.

Furthermore, it will be-appreciated that the system is exclusive to manufacturers and/or suppliers of products in the sense that only the product manufacturers and/or suppliers registered with the system or associated with the system are able to display their products on the website, and that the system is exclusive to users in the sense that only users registered with the system are able to avail themselves of the offers and rewards associated with products available on the website.

It will also be appreciated that while each registered user may only purchase products from one manufacturer or supplier registered with the system, by providing the website containing rewards of all registered manufacturers and/or suppliers, the registered manufacturers and/or suppliers have access to all users registered with the system.

Modifications and variations as would be apparent to a skilled addressee are deemed to be within the scope of the present invention.

The claims defining the invention are as follows:

1. A system for promoting products including at least one terminal disposed at a point of sale, said terminal including a communications device for facilitating transfer of communications through a communications network, and said terminal being arranged to receive an electronic address of a user, and an electronic message generator arranged to generate an electronic message and forward the electronic message to the electronic address of the user, said electronic message including an address of a network information site and a password useable to access the network information site.

2. A system as claimed in claim 1, wherein the electronic address of the user is received as part of an off line transaction.

3. A system for promoting products as claimed in claim 1, further including a central controller, wherein said terminal is arranged to generate an intermediate electronic message and forward the intermediate electronic message to the central controller, said intermediate electronic message including information indicative of the electronic address of the user.

4. A system for promoting products as claimed in claim 1, further including a database for storing information relating to electronic messages, purchased product information and/or user demographic information.

5. A system for promoting products as claimed in claim 1, wherein the terminal is a communications enabled vending machine.

6. A system for promoting products as claimed in claim 1, wherein the terminal is a communications enabled computing device.

7. A system for promoting products as claimed in claim 5,
wherein the communications device is arranged to facilitate communications through the Internet.

8. An electronic messaging machine as claimed in claim 7, wherein the electronic message is an e-mail and the electronic address is an e-mail address.

9. A system for promoting products as claimed in claim 5,
wherein the communications device is arranged to facilitate communications through a mobile telephone communications network.

10. A system for promoting products as claimed in claim 9, wherein the electronic message is an SMS message and the electronic address is a telephone number of a mobile telephone.

11. A system for promoting products as claimed in claim 1, wherein the network information site is a website including information relating to rewards, and/or to products and/or services on offer.

12. A system as claimed in claim 1, wherein the system includes the network information site.

13. A method of promoting products including the steps of providing at least one terminal disposed at a point of sale, said terminal includes a communications device for facilitating transfer of communications through a communications network, receiving an electronic address of a user at said terminal, generating an electronic message including an address of a network information site and a password useable to access the network information site, and forwarding the electronic message to the electronic address of the user.

14. A method as claimed in claim 13, wherein the electronic address of a user is received as part of an off line transaction.

15. A method as claimed in claim 13, further including the steps of providing a central controller, generating an intermediate electronic message, and forwarding the intermediate electronic message to the central controller, said intermediate electronic message including information indicative of the electronic address of the user.

16. A method as claimed in claim 13, further including the step of providing a database for storing information relating to electronic messages, purchased product information and/or user demographic information.

17. A method as claimed in claim 13, wherein the terminal is a communications enabled vending machine.

18. A method as claimed in claim 13, wherein the terminal is a communications enabled computing device.

19. A method as claimed in claim 17, further including the step of arranging the communications device to facilitate communications through the Internet.

20. A method as claimed in claim 19, wherein the electronic message is an e-mail and the electronic address is an e-mail address.

21. A method as claimed in claim 17, further including the step of arranging the communications device to facilitate communications through a mobile telephone communications network.

22. A method as claimed in claim 21, wherein the electronic message is an SMS message and the electronic address is a telephone number of a mobile telephone.

23. A method as claimed in claim 13, wherein the network information site is a website including information relating to rewards, and/or to products and/or services on offer.
